(19) United States
(12) Patent Application Publication
(10) Pub. No.: US 2010/0332491 A1
(43) Pub. Date: Dec. 30, 2010

(54) METHOD AND SYSTEM FOR UTILIZING USER SELECTION DATA TO DETERMINE RELEVANCE OF A WEB DOCUMENT FOR A SEARCH QUERY

(75) Inventors: Hang Cui, San Jose, CA (US); Srihari Reddy, Santa Clara, CA (US); Donald Metzler, Santa Clara, CA (US)

Correspondence Address: BERKELEY LAW & TECHNOLOGY GROUP LLP, 17933 NW EVERGREEN PARKWAY, SUITE 250, BEAVERTON, OR, 97006, US

(73) Assignee: Yahoo!, Inc., a Delaware corporation, Sunnyvale, CA (US)

(21) Appl. No.: 12/491,463

(22) Filed: Jun. 25, 2009

(51) Int. Cl. G06F 17/30

(52) U.S. Cl. 707/759; 707/769; 707/713

(57) ABSTRACT

Methods and systems are provided that may be used to utilize user selection data on web documents in a list of search results to provide relevant search results in response to a search query.

### BACKGROUND

1. Field

The subject matter disclosed herein relates to a method and system for determining relevance of a web document for a particular search query.

2. Information

Data processing tools and techniques continue to improve. Information in the form of data is continually being generated or otherwise identified, collected, stored, shared, and analyzed. Databases and other like data repositories are common place, as are related communication networks and computing resources that provide access to such information.

The Internet is ubiquitous; the World Wide Web provided by the Internet continues to grow with new information seemingly being added every second. To provide access to such information, tools and services are often provided which allow for the copious amounts of information to be searched through in an efficient manner. For example, service providers may allow for users to search the World Wide Web or other like networks using search engines. Similar tools or services may allow for one or more databases or other like data repositories to be searched.

There is a wide variety of web documents available on the World Wide Web. Some of these web documents may contain information of interest such as, text or other descriptions relating to a certain topic. Such web documents can be presented in a variety of different formats.

With so much information being available, there is a continuing need for methods and systems that allow for relevant information to be identified and presented in an efficient manner.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is a block diagram illustrating certain processes, functions and/or other like resources of an exemplary computing environment according to one implementation.

FIG. 2 is a diagram of query logs stored in a user selection database according to one implementation.

FIG. 3 is a flow diagram illustrating a process for determining a list of web documents for a search query based at least in part on user selection information according to one implementation.

FIG. 4 is a schematic diagram illustrating a computing environment system that may include one or more devices configurable to perform a search using one or more techniques illustrated above, for example, according to one implementation.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

The Internet is a worldwide system of computer networks and is a public, self-sustaining facility that is accessible to tens of millions of people worldwide. Currently, the most widely used part of the Internet appears to be the World Wide Web, often abbreviated “WWW” or simply referred to as just “the web.” The web may be considered an Internet service organizing information through the use of hypermedia. Here, for example, the HyperText Markup Language (HTML) may be used to specify the contents and format of a web document (e.g., a web page).

Unless specifically stated, a “web document,” as used herein, may refer to either the source code, data, and/or a file accessible or identifiable in a search. A web document may comprise an HTML web page, an Extensible Markup Language (XML) document, or a media file, to name a few among many possible examples of web documents. A web document may, for example, include embedded references to images, audio, video, other web documents, etc., just to name a few examples.

One common type of reference used to identify and locate resources on the web is a Uniform Resource Locator (URL).

In the context of the web, a user may “browse” for information by following references that may be embedded in each of the documents, for example, using hyperlinks provided via the HyperText Transfer Protocol (HTTP) or other like protocols.

Through the use of the web, users may have access to millions of pages of information. However, because there is so little organization to the web, at times it may be extremely difficult for users to locate the particular web documents that contain the information that may be of interest to them. To address this problem, a mechanism known as a “search engine” may be employed to index a large number of web documents and provide an interface that may be used to search the indexed information, for example, by entering certain words or phrases to be queried.

A search engine may, for example, be part of an information integration system that may also include a “crawler” or other process that may “crawl” the Internet in some manner to locate web documents. Upon locating a web document, such a crawler may store the web document's URL, and possibly follow hyperlinks associated with the web document, for example to locate other web documents.

An information integration system may also include an information extraction engine or other like process adapted to extract and/or otherwise index certain information about the web documents that were located by the crawler. Such index information may, for example, be generated based on the contents of an HTML file associated with a web document and may be included in a stored index, for example within a database.

A search engine may allow users to search the database, for example, via a user interface that allows a user to input or otherwise specify search query terms (e.g., keywords or other like criteria) and receive and view search results. A search engine may, for example, present search result summaries in a particular order as may be indicated by a ranking function or other like process. A search result summary may, for example, include information about a web document such as a title, an abstract, a link, and/or possibly one or more other related objects to assist a user in deciding whether to access the web document.

Should a user decide to access a web document based on the search result summary, then the user may, through a user interface, indicate such desire by initiating access to the web document. For example, a user may select a link or other like selectable mechanism within a search result summary to initiate access to the web document through a browser or other like process that may be used to access and render web documents on a display device. A user may select a link by using a mouse, touch screen, track ball, or any other type of device capable of receiving a user input for selecting an item.

Some implementations of a search engine may analyze a particular web document to determine relevant items for characterizing such as a web document. Relevant items may include, for example, key words utilized within a title, a URL, or within a body of a web document containing text. “Key words,” as used herein, may refer to a single word or multiple words in a phrase, for example, contained within a web document that may indicate a subject matter of a web document. For example, the phrase “car sales” within a web document may be a key word that may indicate that the subject matter of the web document is related to car sales. A search engine may store such relevant items in a searchable index.

Some implementations of a search engine may also utilize anchor text to further characterize a web document. “Anchor text,” as used herein, may refer to one or more characters and/or words characterizing or indicating a subject matter of a first web document. Anchor text may be included within link, for example, on a second web document, where the link references the first web document. For example, if a second web document contains the phrase “car sales in Southern California,” and that entire phrase, if selected, may redirect a user's web browser or other application for searching and/or viewing web documents back to the first web document, that phrase may therefore be considered anchor text for the first web document. Accordingly, anchor text may be associated with a first web document even though such anchor text may not actually be contained within the first web document. Such anchor text therefore is utilized to characterize a first web document. While crawling the web, if there are numerous web documents with the same or similar key words linking back to the first web document, such anchor text may be considered to be highly relevant for determining the subject matter of the first web document. Accordingly, such anchor text may be stored as an annotation to the first web document in a database containing information characterizing the first web document.

If a user enters a particular search query into a search engine through a web site, such as yahoo.com, for example, such a search query may be matched against a set of web documents. A search query may be matched against a set of web documents based on, for example, key words, titles, URLs, and anchor text, for example, for such web documents. Based on such a comparison, a list of web documents related to the search query may be determined and presented to a user. Web documents in the list may be ordered based on relevance to the search query. However, although anchor text may characterize a web document, search engines may still occasionally present web documents for a search query that are unrelated to the search query.

According to one implementation, additional information external to a web document may be utilized to characterize relevance of a web document relative to a particular search query. A list of search results for a particular query may be determined and presented to a user. The list of search results may contains links, such as URLs, to various relevant web documents. A user may select particular web documents corresponding to the links within the list. A user may select a particular web document by selecting a corresponding link with a pointing device, such as a mouse, or via a touch screen, trackball, stylus, or any other device for selecting a link based on a user input. The particular web documents which a user selects may be recorded and saved in a user selection database, for example. Based upon which web documents are selected for particular queries, a determination may be made as to the relevance of one or more particular web documents for a particular query. Accordingly, end users may effectively rate the list of web documents in the search results based upon which web documents are actually selected by such end users.

If a search query is later submitted via a search engine, for example, previously recorded user selection data may be accessed and may be utilized to determine appropriate relevant search results for such a search query. Using such previously recorded user selection data may help to improve the relevance of search results for a particular search query.

User queries associated with selections of certain web documents may be considered off-page annotations to such web documents, and thus provide additional meta-data for search. User selection of particular web documents implicitly indicates the relevance between queries and documents. In one implementation, user queries may be utilized as a new field of document representation for web documents and such user queries may be weighed based on user selections of web documents in search results.

Recent years have witnessed prosperous growth in Web search. People are relying more on the web to obtain necessary information. Search engines act as a bridge to connect information needs of people to the information available on the web. Web search is difficult due to its dynamic nature—both web documents and search queries are changing rapidly. One issue for web search is how to represent web documents to better serve user information needs. Web documents may be represented with structure in document fields such as title and body, and additional fields for anchor text, for example. Search engines may treat anchor text from incoming links for a web document as part of the web document, and perform similarity measurement with a user search query against anchor text, title, and body. Although anchor text is a source of off-page annotation for web documents, it is added by web document editors and is not updated frequently. Accordingly, it may not completely address the problem of bridging the lexical gap between web documents and user queries given the dynamics of the Internet.

As discussed above, users of Internet search engines may provide implicit relevance feedback in the form of selections of web documents during search sessions. With the accumulation of user queries and search behaviors, user search logs have become another source for capturing user intent. User search logs may record each session of user search behaviors, including issued queries, results, and web documents selected by the user. Such user queries in search logs may therefore be used as another off-page annotation to web documents which are selected by users using these search queries. In addition, user behaviors, as indicated by selections of relevant web documents, may be utilized to give prior importance (or weights) to the search queries associated with web documents. One reason for utilizing such search queries is because users may not randomly select web documents, especially given that a presentation of search results by current search engines has been greatly improved by using title, URL and summary with highlighted search keywords.

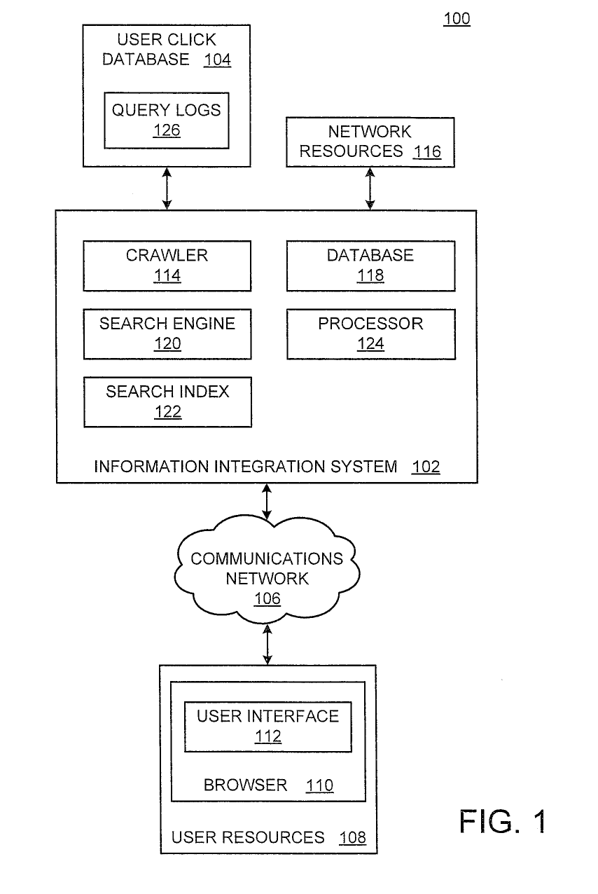

FIG. 1 is a block diagram illustrating certain processes associated with an exemplary computing environment 100 having an Information Integration System (IIS) 102 according to one implementation. The context in which such an IIS may be implemented may vary. For non-limiting examples, an IIS such as IIS 102 may be implemented for public or private search engines, job portals, shopping search sites, travel search sites, RSS (Really Simple Syndication) based applications and sites, and the like. In certain implementations, IIS 102 may be implemented in the context of a World Wide Web (WWW) search system, for purposes of an example. In certain implementations, IIS 102 may be implemented in the context of private enterprise networks (e.g., intranets), as well as the public network of networks (i.e., the Internet).

As illustrated in FIG. 1, IIS 102 may be operatively coupled to a user selection database 104 and to a communications network 106. An end user may communicate with IIS 102 via communications network 106. For example, an end user may desire to search for web documents related to a certain topic of interest. Such a user may access a search engine website and submit a search query. A user may utilize user resources 108. User resources 108 may comprise a computer, a personal digital assistant (PDA), or a cellular phone with access to the Internet, to name just a few among many examples. User resources 108 may permit a browser 110 to be executed. Browser 110 may be utilized to view and/or otherwise access web documents on the Internet. User resources 108 may also include a user interface 112. User interface 112 may include, for example, a computer monitor and/or various user input devices, such as a microphone, a computer mouse, a keyboard, pointing device, touch screen, and output devices such as a display and speakers, to name just a few among many types of user input devices and output devices.

A user may access a website for a search engine and may submit a search query. A search query may be transmitted from user resources 108 to IIS 102 via communications network 106. IIS 102 may determine a list of web documents tailored based on relevance and may transmit such a list back to user resources 108 for display, for example, on user interface 112.

IIS 102 may include a crawler 114 to access network resources 116, which may include, for example, the Internet and the World Wide Web (WWW), one or more servers, etc. IIS 102 may include a database 118, a search engine 120 backed, for example, by a search index 122. IIS 102 may further include a processor 124 and/or controller to implement various modules, for example.

Crawler 114 may be adapted to locate web documents such as, for example, web documents associated with websites, etc. In one particular implementation, crawler 114 may implement a “Mozilla™-based crawl” in which, for example, fetching is performed based on a Mozilla Foundation™ source code or a modification of Mozilla Foundation™ source code. Crawler 114 may also follow one or more hyperlinks associated with a web document to locate other web documents. Upon locating a web document, crawler 114 may, for example, store the web document's URL and/or other information in database 118. Crawler 114 may, for example, store all or part of a web document (e.g., HTML, XML, object, and/or the like) and/or a URL or other like link information in database 118.

Upon receiving a search query, IIS 102 may also access user selection database 104 to determine previously stored user selections of various web documents associated with the search query. Such previously stored user selections may be stored in query logs 126 and may be utilized to provide more relevant search results than would be possible without using such previously stored user selections for a given search query.

In one implementation, search queries may be utilized as a field in a representation of a web document in a database, for example. A database may store information used to characterize a web document such as, for example, key words in a body of text, one or more titles, anchor text, and previous user selections of web documents for a particular search query. Such information may be stored in an index in the database, for example. Search queries may be weighed based on their associated user selections of web documents listed in search results. Search queries for which users select a particular web document may be retrieved from search logs for the web document. Such search queries may be combined into a new field for the representation of the web document. The new field, referred to herein as “QueryText,” may be considered a text field for the representation of the web document, along with other fields such as title, body and anchor text. In a QueryText field, a search query may consist of one line of text and a weight that represents a relevance of the search query to a web document. Such weight may be determined by query impressions (occurrences of a query in a query log) and click-through rate (CTR) on the given web document.

To utilize a QueryText field, two sets of features may be derived from this field—relevance features for whole queries and n-gram features. “N-gram features,” as used herein may refer to instances where n consecutive words and/or items in a web document are contained and are determined to have a certain meaning and may be utilized to characterize content of a web document.

Relevance features are calculated values which are utilized by the search engine to determine the relevance of a document and a query. Examples of relevance features are text matching features, link structure features, and user selection features. Relevance features, including text matching features, may be directly calculated for a QueryText field. N-gram features may also be derived from this field. Long queries may be problematic if words or characters in a particular query are not commonly located in close proximity to each other in a web document, for example. N-gram features may better address proximity issues for long queries and may be effective for improving long queries (e.g., queries with 4 or more words). Queries may be segmented into bigrams (instances of two consecutive words and/or items) and trigrams (instances of three consecutive words and/or items), and weights may be assigned to them using the original weights of the queries from which such n-grams are obtained. N-gram features may provide improved proximity measurement for long queries while leveraging the new field. Both text matching features and n-gram features obtained from user queries may improve the relevance of the search results obtained by a search engine.

According to an implementation as discussed herein, user selections may be taken into account for calculating weights for a QueryText document field. User behaviors recorded in query logs may be incorporated into a scoring scheme for the QueryText document field. A scheme of weighting using query impressions and CTR on web documents may be utilized. There are additional ways of weighting queries. Other weighting schemes include, but are not limited to, user selection and browsing patterns, result-skipping, and visual tracking, for example.

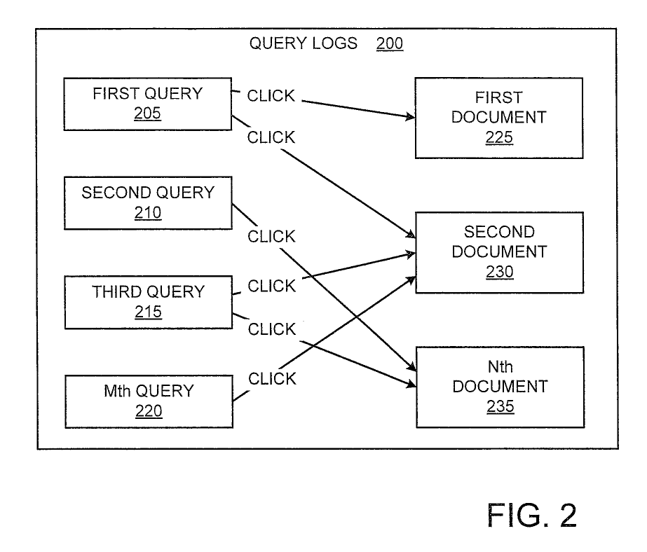

FIG. 2 is a diagram of query logs 200 stored in a user selection database according to one implementation. Query logs 200 may store identities of various queries which have previously be performed, such as a first query 205, a second query 210, a third query 215, and so forth up through an Mth query 220. Query logs 200 may also store the identities of various web documents which were previously presented as results for various search queries. For example, identities, such as URLs, for a first document 225, a second document 230, and an Nth document 235 may be stored.

Query logs 200 may also store information indicating which documents selected while presented as results for various search queries. In this example, first query 205 resulted in user selections of first document 225 and second document 230. Second query 210 resulted in a user selection of only Nth document 235. Third query 215 resulted in user selections of second document 230 and Nth document 235. Mth query 220 resulted in a user selection of only second document 230.

A query normalization process may be implemented to remove punctuations and extra spaces from search queries after being saved in query logs 200. In addition, a stop word list of common words may be utilized to remove common words, such as “a” or “the,” from search queries. To reduce the impact of noisy and random selections, search queries may be filtered based on a threshold on query impressions (e.g., a number of occurrences for a search query in a particular time period) and selections of a web document. For example, search queries with impressions lower than five in a period of six months may be filtered out. In one implementation, queries for a particular web document may be classified based at least in part on a threshold number of times that the web document was selected. For example, the threshold number of times may be two selections in one implementation. Such an aggregation process may be performed across user sessions.

After storing queries associated with selected web documents, such search queries for a particular web document may be stored in a new QueryText field for that particular web document, in parallel with existing fields such as title, body and anchor text. A query in the QueryText field may occupy one line, associated with a weight indicating a relevance of the query to the web document. The weight may be calculated based on user selections stored in query logs in a user selection database.

Table 1 shown below lists examples of anchor text and QueryText for example URLs. This table may be stored within a user selection database, for example. Table 1 illustrates anchor text and query text keywords and associated relevance scores. Table 1 shows that QueryText annotates a web document. For instance, the second URL shown below is annotated with QueryText keywords such as “resume”, “common” and “mistakes,” which may expand the lexical coverage of the web document associated with the second URL. QueryText may also occasionally provide a different emphasis on certain keywords than does anchor text. For the third URL in Table 1, for example, anchor text biases on “Mike Pelly,” whereas QueryText has more emphasis on “biodiesel.” As QueryText comes from user queries, it may bridge a gap between the vocabulary of users and document keywords.

TABLE 1
Examples of URLs with Anchor Text and Query Text

| URL | Anchor Text | Query Text |
|---|---|---|
| baking.about.com/ | Chocolate Ice Cream | homemade chocolate ice |
| od/icecream/r/ | 19.0 | cream recipe 11.50 |
| choco.htm | Chocolate 11.0 | homemade chocolate |
| | | chip ice cream recipe |
| | | 3.60 |
| Career- | Sample Internship | cover letter for internship |
| advice.moster.com/ | Cover Letter 1.0 | 3.36 |
| Pitch-Yourself- | | sample internship resume |
| for-an-Internship/ | | and cover letter 1.56 |
| | | common cover letter |
| | | mistakes 0.60 |
| Journeytoforever.org/ | Mike Pelly's Biodiesel | biodiesel recipe 3.68 |
| biodiesel_mike.html | Method 7.33 | biodiesel soap 2.05 |
| | Mike Pelly's | how to make your own |
| | recipe 6.75 | diesel fuel 1.98 |
| | Mike Pelly's biodiesel | mike pelly biodiesel 1.65 |
| | recipe 4.25 | |

While performing a logical ordering or ranking for a given search query, a feature extraction module may extract text matching features from each field as input features to a ranking function. A ranking function may be learned from human-judged search query-URL pairs following a regression analysis. Such a text-matching process may utilize different scoring schemes for different fields.

Text matching features, or content matching features, may measure how well a search query matches against a textual representation of a document. While current commercial search engines may employ many other features (e.g. query-independent features), text matching features are still the prevalent features in ranking functions. Ranking functions may perform text match in different fields of a web document and determine weights for the fields to assemble their scores.

Two sets of features may be derived from weighted queries for each web document—relevance features and query n-gram features. Relevance features may measure how well a given query is matched against the text of multiple queries in a QueryText field. A set of query n-gram features may also be introduced to address long queries, such as queries having three or more query words. A large number of uncommon queries may consist of three or more query words. Long queries may return fewer, and sometimes lower quality, results than short queries. As such, some web documents associated with long queries may not be associated with enough queries to determine an accurate weighting for the QueryText field. To address this potential issue, queries may be segmented into bigrams and trigrams. Such bigrams and trigrams may then be weighed by a CTR of their original search queries prior to such segmenting. Features from such n-grams may subsequently be derived. Such n-gram features may then be aggregated in a QueryText field for a given web document.

A representation of a web document may be stored as a structured series of files. Each file in such a series may be representative of an associated portion or feature of the web document. For example, a first file may represent a title of the web document, a second file may represent a body of the web document, and a third file may represent QueryText.

A set of query n-gram features may be evaluated by a search engine. N-gram features may be derived directly from selection-associated queries presented and may inherit weights (e.g., as shown in Table 1) of search queries from which they originate. In one implementation, bigrams and trigrams may be extracted from search queries. For example, a search query “northern California car sale” may generate bigrams “northern California,” “California car,” and “car sale,” as well as trigrams “northern California car” and “California car sale.” Weights for an n-gram to a certain page are the weights for the search query to that web document, for example, as determined by query impression and a CTR on the web document.

In this example, QueryText may be represented as a list of n-grams with assigned weights. Given a new query, it may also be segmented to bigrams and trigrams which may be matched against the n-grams in the field to retrieve feature values. Features that are derived from the matched bigrams and trigrams are used as input features to a rank function. An example set of n-gram features is shown below in Table 2.

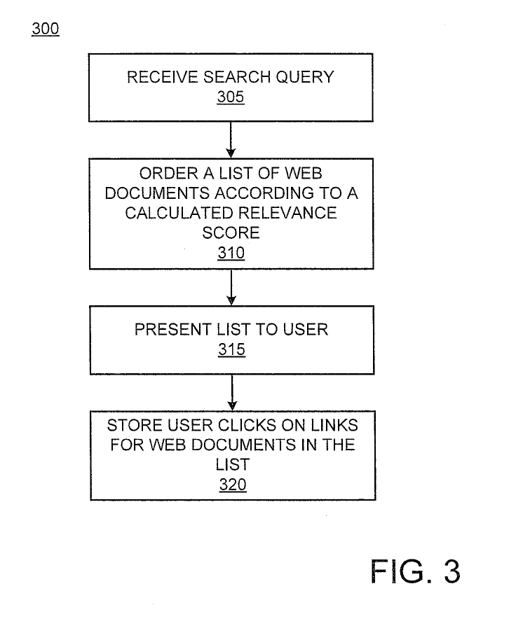

FIG. 3 is a flow diagram 300 illustrating a process for determining a list of web documents in response to a search query based at least in part on user selection information according to one implementation. First, a user at a computer with access to the Internet, for example, may submit a search query into a search engine. The user's computer may transmit the search query as one or more digital signals across the Internet or some other communications network. The one or more digital signals representing the search query may be received at operation 305 by a server or other device, for example. Next, at operation 310, the server or other device may order a list of links, such as URLs, to web documents according to a calculated relevance score in response to the search query. A calculated relevance score may be based, at least in part, on previously determined user selections of links for web documents associated with the search query. Next, at operation 315, the ordered list is presented to a user. The ordered list may be transmitted to the user's computer, for example, via one or more digital signals. Upon receiving such digital signals, a user's computer may display the ordered list. For example, a list of search results may be presented on a display device. Finally, at operation 320, any selections by the user of any of the web documents listed in the search results may be stored in a user selection database. For example, in the event that the user selects a particular web document, a signal may be transmitted for subsequent storage to a user selection database that indicates that the web document was selected.

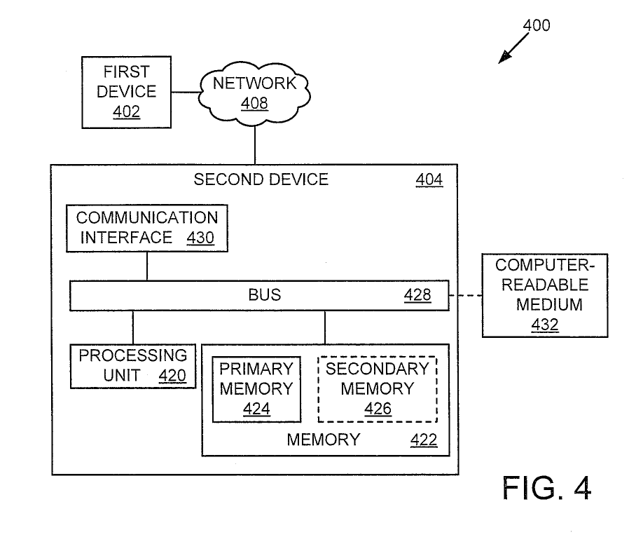

FIG. 4 is a schematic diagram illustrating a computing environment system 400 that may include one or more devices configurable to perform a search using one or more techniques illustrated above, for example, according to one implementation. System 400 may include, for example, a first device 402 and a second device 404, which may be operatively coupled together through a network 408.

First device 402 and second device 404, as shown in FIG. 4, may be representative of any device, appliance or machine that may be configurable to exchange data over network 408. First device 402 may be adapted to receive a user input from a program developer, for example. By way of example but not limitation, either of first device 402 or second device 404 may include: one or more computing devices and/or platforms, such as, e.g., a desktop computer, a laptop computer, a workstation, a server device, or the like; one or more personal computing or communication devices or appliances, such as, e.g., a personal digital assistant, mobile communication device, or the like; a computing system and/or associated service provider capability, such as, e.g., a database or data storage service provider/system, a network service provider/system, an Internet or intranet service provider/system, a portal and/or search engine service provider/system, a wireless communication service provider/system; and/or any combination thereof.

Similarly, network 408, as shown in FIG. 4, is representative of one or more communication links, processes, and/or resources configurable to support the exchange of data between first device 402 and second device 404. By way of example but not limitation, network 408 may include wireless and/or wired communication links, telephone or telecommunications systems, data buses or channels, optical fibers, terrestrial or satellite resources, local area networks, wide area networks, intranets, the Internet, routers or switches, and the like, or any combination thereof.

It is recognized that all or part of the various devices and networks shown in system 400, and the processes and methods as further described herein, may be implemented using or otherwise include hardware, firmware, software, or any combination thereof.

Thus, by way of example but not limitation, second device 404 may include at least one processing unit 420 that is operatively coupled to a memory 422 through a bus 428.

Processing unit 420 is representative of one or more circuits configurable to perform at least a portion of a data computing procedure or process. By way of example but not limitation, processing unit 420 may include one or more processors, controllers, microprocessors, microcontrollers, application specific integrated circuits, digital signal processors, programmable logic devices, field programmable gate arrays, and the like, or any combination thereof.

Memory 422 is representative of any data storage mechanism. Memory 422 may include, for example, a primary memory 424 and/or a secondary memory 426. Primary memory 424 may include, for example, a random access memory, read only memory, etc. While illustrated in this example as being separate from processing unit 420, it should be understood that all or part of primary memory 424 may be provided within or otherwise co-located/coupled with processing unit 420.

Secondary memory 426 may include, for example, the same or similar type of memory as primary memory and/or one or more data storage devices or systems, such as, for example, a disk drive, an optical disc drive, a tape drive, a solid state memory drive, etc. In certain implementations, secondary memory 426 may be operatively receptive of, or otherwise configurable to couple to, a computer-readable medium 432. Computer-readable medium 432 may include, for example, any medium that can carry and/or make accessible data, code and/or instructions for one or more of the devices in system 400.

Second device 404 may include, for example, a communication interface 430 that provides for or otherwise supports the operative coupling of second device 404 to at least network 408. By way of example but not limitation, communication interface 430 may include a network interface device or card, a modem, a router, a switch, a transceiver, and the like.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated.

It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all implementations falling within the scope of the appended claims, and equivalents thereof.

What is claimed is:

1. A method, comprising:
executing instructions, by a special purpose computing device, to direct the special purpose computing device to:
order an index of web documents according to a relevance score in response to digital signals representing a search query, the relevance score being based, at least in part, on previous user selections of web documents associated with the search query;
initiating transmission of first binary digital signals representative of the index of web documents via the communication interface to a user device; and
storing second binary digital signals representative of current user selections of the web documents in the index as part of a user selection database, the user selection database storing previous user selections of the web documents.

2. The method of claim 1, wherein the instructions, in response to being executed by the special purpose computing device, further direct the special purpose computing device to display, on the user device, the index of web documents based on the first binary digital signals.

3. The method of claim 1, wherein the instructions, in response to being executed by the special purpose computing device, further direct the special purpose computing device to associate the previous user selections with particular search queries in the user selection database.

4. The method of claim 1, wherein the instructions, in response to being executed by the special purpose computing device, further direct the special purpose computing device to segment a search query longer than a predetermined length into one or more features based on a predetermined amount of consecutive searchable items in the web documents.

5. The method of claim 1, wherein the instructions, in response to being executed by the special purpose computing device, further direct the special purpose computing device to store third binary digital signals representative of search queries and user selection information associated with a specific web document as annotations to the web document in a database.

6. The method of claim 1, wherein the instructions, in response to being executed by the special purpose computing device, further direct the special purpose computing device to determine the order of the list of web documents based, at least in part, on text matching between the web documents, the search query, and at least the previously determined user selections.

7. An apparatus comprising:
a communication interface adapted to at least transmit digital signals through a communication network;
a special purpose computing device programmed with instructions to:
order an index of web documents according to a relevance score in response to digital signals representing a search query, the relevance score being based, at least in part, on previous user selections of web documents associated with the search query;
initiate transmission of first binary digital signals representative of the index of web documents via the communication interface to a user device; and
store second binary digital signals representative of the selections of the web documents in the index as part of a user selection database, the user selection database storing previous user selections of the web documents.

8. The system of claim 7, wherein the special purpose computing device is adapted to associate the previous user selections with particular search queries in the user selection database.

9. The system of claim 7, wherein the communication network is adapted to receive the search query from the user device.

10. The system of claim 7, wherein the special purpose computing device is adapted to store second binary digital signals representative of search queries and user selection information associated with a specific web document as annotations to the specific web document in a database.

11. The system of claim 7, wherein the special purpose computing device is adapted to determine the order of the index of web documents based on text matching between the web documents, the search query, and at least the previously user selections.

12. The system of claim 7, wherein the special purpose computing device is adapted to segment a search query longer than a predetermined length into one or more features based on a predetermined amount of consecutive searchable items in the web documents.

13. An article comprising:
a storage medium comprising machine readable instructions stored thereon which, in response to being executed by a special purpose computing device, are adapted to direct the special purpose computing device to:
order an index of web documents according to a relevance score in response to digital signals representing a search query, the relevance score being based, at least in part, on previous user selections of web documents associated with the search query;
initiating transmission of first binary digital signals representative of the index of web documents via the communication interface to a user device; and
storing second binary digital signals representative of current user selections of the web documents in the index as part of a user selection database, the user selection database storing previous user selections of the web documents.

14. The article of claim 13, wherein the machine readable instructions, in response to being executed by a second special purpose computing device, are adapted to display, on the user device, the index of web documents based on the first binary digital signals.

15. The article of claim 14, wherein the machine readable instructions, in response to being executed by a second special purpose computing device, are adapted to associate the previous user selections with particular search queries in the user selection database.

16. The article of claim 13, wherein the machine readable instructions, in response to being executed by a second special purpose computing device, are adapted to segment a search query longer than a predetermined length into one or more features based on a predetermined amount of consecutive searchable items in the web documents.

17. The article of claim 13, wherein the machine readable instructions, in response to being executed by a second special purpose computing device, are adapted to store third binary digital signals representative of search queries and user selection information associated with a specific web document as annotations to the web document in a database.

18. The article of claim 13, wherein the machine readable instructions, in response to being executed by a second special purpose computing device, are adapted to determine the order of the list of web documents based, at least in part, on text matching between the web documents, the search query, and at least the previously determined user selections.
